(19) United States
(12) Patent Application Publication
(10) Pub. No.: US 2005/0084347 A1
(43) Pub. Date: Apr. 21, 2005

(54) Countersink

(76) Inventor: Arthur H. Clark, Atherley (CA)

Correspondence Address: CLARK & BRODY, 1090 VERMONT AVENUE, NW, SUITE 250, WASHINGTON, DC, 20005, US

(21) Appl. No.: 10/953,605

(22) Filed: Sep. 30, 2004

(30) Foreign Application Priority Data
Oct. 15, 2003 (CA) 2,444,472

(51) Int. Cl. B23B 51/02

(52) U.S. Cl. 408/189

(57) ABSTRACT

The present invention provides a device for forming countersinks on a piece of material at a non-perpendicular angle. The device can be easily adjusted to vary the depth of the hole to be drilled, and is of simple construction. The device is an elongate tube that defines a continuous opening along its central longitudinal axis. The opening extends through the first and second end, and is adapted to receive a drill bit therethrough. The first end has at least one cutting edge for forming a countersink. The second end defines at least one slot parallel to the central axis and extends along the tube outer surface, to allow circumferential compression of the tube when squeezed by a drill chuck.

### FIELD OF INVENTION

The present invention relates to cutting tool accessories generally, and more particularly to countersinks for use in drills and similar tools.

### BACKGROUND OF THE INVENTION

In wood working it is often necessary to drill holes with countersinks (for fasteners or plugs) to achieve functional and/or aesthetic results. Countersinks such as the type shown in Russel (U.S. Pat. No. 303,053) grip and stabilize a drill bit by providing teeth that bite into flutes of the drill bit. Countersinks of this type cause excessive wearing of drill bits.

Other countersinks like the type shown in Wilkins (U.S. Pat. No. 4,580,933) use collars to stabilize a drill bit held therein. Apart from being cumbersome to use, these collars often limit the utility of the drill by preventing a user from drilling a countersink on a non-perpendicular angle.

Other countersinks are known to employ collar and screw combinations. These countersinks are cumbersome to handle, damage easily, and can also prevent users from drilling countersinks on non-perpendicular angles.

### SUMMARY OF THE INVENTION

In accordance with an aspect of the present invention there is provided a device for forming a countersink comprising an elongate tube. The tube defines a first and second end, an inner and outer surface, an inner and outer diameter, a longitudinal central axis, and a continuous opening extending through the first and second end along the central axis. The continuous opening has a diameter that is the inner diameter, and is adapted to receive a drill bit therethrough. The first end has at least one cutting edge for forming a countersink. The second end defines at least one slot parallel to the central axis and extends along the tube outer surface, to allow circumferential compression of the tube.

Other advantages, features and characteristics of this aspect of the present invention, as well as methods of operation and functions of the related elements of the structure, and the combination of parts and economies of manufacture, will become more apparent upon consideration of the following detailed description with reference to the accompanying drawings, the latter of which is briefly described hereinbelow.

### DESCRIPTION OF THE DRAWINGS

FIG. 1 is perspective view of a device for forming a countersink and having two off-centre compressible slots on the device;

FIG. 2 is a disassembled perspective view of the countersink device with compressible slots and drill bit combination;

FIG. 3 is an assembled perspective view of the countersink device and drill bit combination;

FIG. 4 is a cross-sectional view taken along the line 4-4 in FIG. 3;

FIG. 4A is a cross-sectional view similar to FIG. 4 but showing one compressible slot only;

FIG. 4B is a cross-sectional view similar to FIG. 4 showing two compressible slots in a centered arrangement;

FIG. 4C is a cross-sectional view similar to FIG. 4 showing three compressible slots; and

FIG. 5 is a perspective view of the countersink device and the drill bit in operation on a block of material.

### DETAILED DESCRIPTION OF THE DRAWINGS

In the first preferred embodiment of the present invention, there is disclosed a device for forming a countersink generally indicated by reference numeral (10). The device (10) is an elongate tube defining a first (14) and second (18) end.

The device (10) further defines an inner (22) and outer (26) surface, an inner (30) and outer (34) diameter, and a longitudinal central axis (38) (FIGS. 1 and 2).

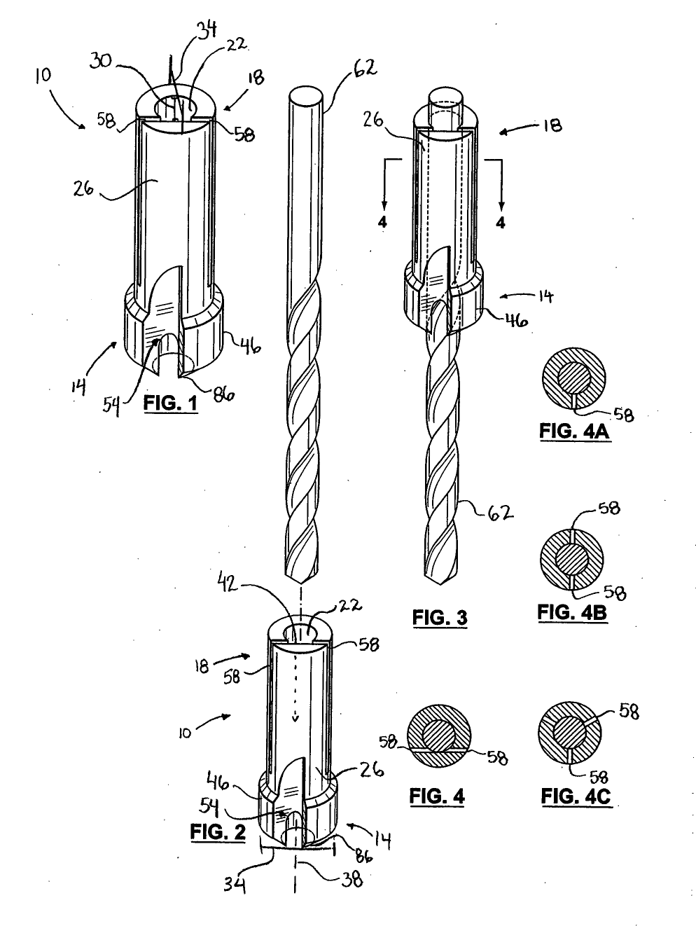

There is a continuous opening (42) which extends through the first (14) and second (18) end along the central axis (38). The continuous opening (42) has a diameter (30) that is the inner diameter (30) of the device (10). The opening (42) is adapted to slidably receive a drill bit (62) therethrough (best seen in FIG. 3).

The first end (14) has at least one cutting head (46) that defines at least one cutting edge (86) for cutting into material (70). The cutting head (46) and cutting edge (86) are shaped according to countersinking needs. For example, the cutting head (46) and cutting edge (86) can be shaped to drill a conical shaped hole (not shown) to allow a screwhead (not shown) to sit flush in a block of material (70), or can be shaped to drill a cylindrical hole (74) to allow placement of a plug (not shown) in the material (70).

The second end (18) defines at least one slot (58) that is parallel to the central axis (38), and extends along the outer surface (26). The number of, and positioning of the at least one slot (58) is such that the second end (18) can be circumferentially compressed by the application of a squeezing force. The at least one slot (58) is in open communication with the continuous opening (42) (best seen in FIG. 3). The at least one compressible slot (58) can be configured in numerous arrangements, examples of which are shown in FIGS. 4, 4A, 4B and 4C.

In the embodiment shown in FIG. 4, two slots (58) extend tangentially to the inner surface (22). In alternate embodiments, FIG. 4A provides one radially-extending slot (58); FIG. 4B provides a pair of radially extending slots (58) spaced 180° apart; and FIG. 4C provides three radially extending slots (58) spaced 60° apart.

The first end (14) can optionally provide at least one discharge opening (54), which extends across the tube first end (14) inner (30) and outer (34) diameter. The discharge opening (54) is in open communication with the continuous opening (42).

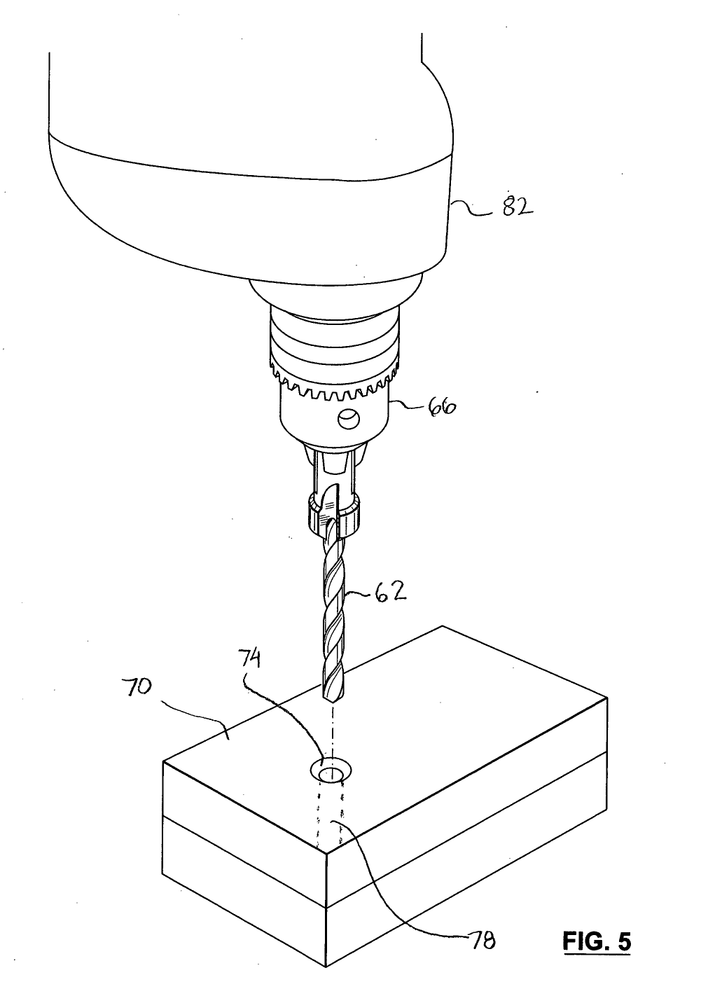

The first end (14) can optionally define an outer diameter (34) that is longer than the outer diameter (34) of the second end (18). Variation of the outer diameter (34) of the first (14) and second (18) ends will vary according to the functional and/or aesthetic result desired in respect of the countersink (74) formed (best seen in FIG. 5).

In operation, the drill bit (62) is slidably inserted into the device (10) opening (42), and can be adjusted in position to vary the depth of the hole (78) to be drilled. The device (10) and drill bit (62) combination is then inserted into a drill chuck (66). The drill chuck (66) is tightened around the device (10) second end (18) to provide a squeezing force that circumferentially compresses the device (10) second end (18) at the slot(s) (58).

The squeezing force results in the second end (18) rigidly grasping and holding the drill bit (62) in place.

As the drill (82) is used in operation on a material (70), the drill bit (62) first contacts the material (70) to create a hole (78). As the device (10) contacts the material (70), it produces a countersink (74). During the formation of the countersink (74), excess (not shown) from the material (70) can be discharged through the discharge opening (54).

The above-described embodiment(s) of the present invention are intended to be examples only. Alterations, modifications and variations may be effected to the particular embodiments by those skilled in the art without departing from the scope of the invention, which is defined by the claims appended hereto.

1. A device for forming a countersink comprising:
an elongate tube defining a first and second end, an inner and outer surface, an inner and outer diameter, a longitudinal central axis, and a continuous opening extending through the first and second end along the central axis, the continuous opening having a diameter that is the inner diameter, and being adapted to receive a drill bit therethrough;
the first end having at least one tooth for forming a countersink;
the second end defining at least one slot parallel to the central axis, the slot extending along the tube outer surface and extending to the tube inner surface, the slot being in open communication with said continuous opening, to allow circumferential compression of the tube.

2. A device for drilling a hole and forming a countersink comprising:
a drill bit;
an elongate tube defining a first and second end, an inner and outer surface, an inner and outer diameter, a longitudinal central axis, and a continuous opening extending through the first and second end along the central axis, the continuous opening having a diameter that is the inner diameter, and being adapted to receive the drill bit therethrough;
the drill bit being slidably inserted in and through said continuous opening, for positioning with the tube for being received in a drill chuck;
the tube first end having at least one tooth for forming a countersink;
the tube second end defining at least one slot parallel to the central axis, the slot extending along the tube outer surface and extending to the tube inner surface, the slot being in open communication with said continuous opening, to allow circumferential compression by the drill chuck of the tube second end around the drill bit when inserted, to rigidly maintain the position of the drill bit within the tube.

3. The device as defined in claim 1 wherein the tube outer diameter of the first end is greater than the tube outer diameter of the second end.

4. The device as defined in claim 1 wherein the tube first end defines at least one discharge opening extending across the tube first end inner and outer diameter, and being in open communication with said continuous opening.

5. The device as defined in claim 1 wherein the number of slots is two.

6. The device as defined in claim 1 wherein the number of slots is three.

7. The device as defined in claim 2 wherein the tube outer diameter of the first end is greater than the tube outer diameter of the second end.
